(19) United States
(12) Patent Application Publication
(10) Pub. No.: US 2006/0038478 A1
(43) Pub. Date: Feb. 23, 2006

(54) EMI shielding film improving color gamut and plasma display device using the same

(76) Inventors: Dong-Gun Moon, Suwon-si (KR); Sang-Min Lee, Suwon-si (KR); Myun-Gi Shim, Suwon-si (KR); Jun-Kyu Cha, Suwon-si (KR); Ik-Chul Lim, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/205,928

(22) Filed: Aug. 17, 2005

(30) Foreign Application Priority Data
Aug. 18, 2004 (KR) 10-2004-0065034

(51) Int. Cl. H01J 1/52; B32B 3/00; B32B 15/00

(52) U.S. Cl. 313/492; 428/209

(57) ABSTRACT

Provided are an electromagnetic interference (EMI) shielding film and a plasma display device including the EMI shielding film. The EMI shielding film includes: an adhesive layer formed on a transparent substrate; a metal pattern formed on the adhesive layer; and a transparent selective light absorbing layer containing a transparent material and a tetraazaphorpyrin compound, which is a selective light absorbing material, and filling the space in the metal pattern on the adhesive layer. The EMI shielding film provides improved color gamut, contrast and thermal stability. Since the EMI shielding film can shield EMI and improve the color gamut, the numbers of binding processes and other additional processes in the manufacturing of filters are reduced. In addition, the EMI shielding film can be directly and easily attached to a panel of a plasma display device.

### CROSS-REFERENCE TO RELATED APPLICATIONS

This application claims the benefit of Korean Patent Application No. 10-2004-0065034, filed on Aug. 18, 2004, in the Korean Intellectual Property Office, the disclosure of which is incorporated herein in its entirety by reference.

### BACKGROUND OF THE INVENTION

1. Field of the Invention

The present embodiments relate to an electromagnetic interference (EMI) shielding film and a plasma display device using the same, and more particularly, to an EMI shielding film, and a plasma display device using the EMI shielding film.

2. Description of the Related Art

Plasma display devices are thin emissive display devices that can be manufactured with large areas more easily than other display devices and are most suitable for high definition digital televisions. However, plasma display devices produce electromagnetic waves as a result of plasma emission and the operation of circuits have inferior color purity characteristic due to the unnecessary emission of near infrared rays caused by inert gas plasma used to induce screen emission. Electromagnetic waves and near infrared rays emitted from plasma display devices are harmful to the human body and cause malfunctions in precision instruments. To overcome such drawbacks and also to reduce surface reflection and improve color purity, a filter is installed on a front side of the plasma display device.

Filters used in plasma display devices are manufactured by forming a conductive layer or a metal mesh on a transparent glass or plastic substrate and coating a near infrared ray blocking and anti-reflecting film on the conductive layer or the metal mesh. Charges on the conductive layer or metal mesh are grounded through a chassis installed in the plasma display device.

FIG. 1 illustrates a structure of a plasma display device using a conventional filter. Referring to FIG. 1, a front filter 11 is installed on a front side of a panel and driving circuit 10 of the plasma display device. The front filter 11 has a structure in which an anti-reflecting layer 13 is formed on an upper surface of a glass or plastic substrate 12, and an EMI shielding layer 14 and a near infrared ray blocking and selective wavelength absorbing film 15 are sequentially formed on a lower surface of the glass or plastic substrate 12. The panel and driving circuit 10 and the front filter 11 are enclosed in a case 16.

A mesh film 20 in FIG. 2 is a conventional filter that can be installed on a front side of a plasma display device.

Referring to FIG. 2, an adhesive layer 22 is formed on a transparent substrate 21, and a metal pattern 23, which is a mesh pattern, is formed on the adhesive layer 22. However, in the mesh film 20, the metal pattern 23 is likely to be damaged or separated from the substrate 21. In addition, when combined with additional film or a glass while the space in the metal pattern 23 is not filled, irregular reflection occurs due to an air layer between the metal pattern 23 and the additional film, thereby reproducing hazy images. Therefore, prior to combining such a mesh film with another member, a process of filling the space in the mesh film with a transparent material is needed. In addition, when such a mesh film is used in a plasma display device, an additional film containing a near infrared ray blocking pigment is attached to the mesh film 22 as shown in FIG. 2.

However, the conventional technique of using additional film together with such a mesh filter complicates the overall filter manufacturing process. In addition, there is a need to reduce haze and improve the transmittance and contrast. The present embodiments address these needs as well as others in the present art.

### SUMMARY OF THE INVENTION

The present embodiments provide an electromagnetic interference (EMI) shielding film that can improve the color gamut and contrast as well as a plasma display device (PDP) using the EMI shielding film.

According to an aspect of the present embodiments, there is provided an EMI shielding which comprises an adhesive layer formed on a transparent substrate; a metal pattern formed on the adhesive layer; and a transparent selective light absorbing layer containing a transparent material and a tetraazaphorpyrin compound, which compound is a selective light absorbing material, and filling the space in the metal pattern on the adhesive layer.

The metal pattern may have a mesh shape.

According to another aspect of the present embodiments, there is provided a plasma display device using the above-described EMI shielding film. The tetraazaphorpyrin compound used as a selective light absorbing material in the present embodiments is thermally stable and may absorb light in a wavelength range of from about 550 to about 610 nm.

The EMI shielding layer may have a transmittance of from about 30 to about 80%, a color temperature of from about 8000 to about 12000K, a conductivity of about 0.5 ohm/square or less, and a red chromaticity coordinate range of from about 0.64 to about 0.70 for x and from about 0.24 to about 0.34 for y.

### BRIEF DESCRIPTION OF THE DRAWINGS

The above and other features and advantages of the present embodiments will become more apparent by describing in detail exemplary aspects thereof with reference to the attached drawings in which:

FIG. 1 is a sectional view illustrating the structure of a plasma display device using a conventional filter;

FIG. 2 is a sectional view illustrating the structure of a conventional filter for a plasma display device;

FIG. 3 is a sectional view illustrating the structure of an electromagnetic interference (EMI) shielding film according to the present embodiments;

FIG. 4 is an exploded perspective view of a plasma display device using the EMI shielding film in FIG. 3; and

FIGS. 5A and 5B respectively illustrate the color characteristics and the optical spectra of the EMI shielding films manufactured in Examples 1 through 6 according to the present embodiments and Comparative Example 1.

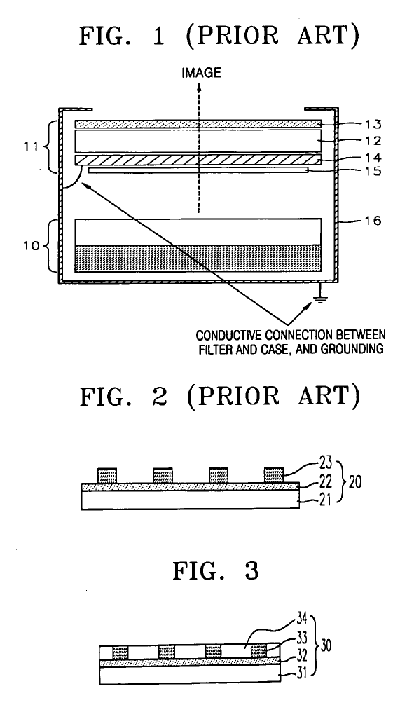

### DETAILED DESCRIPTION OF THE INVENTION

A process of manufacturing an electromagnetic interference (EMI) shielding film according to the present embodiments will be described. In addition, one embodiment is an EMI shielding film with an adhesive layer formed on a transparent substrate, a metal pattern formed on the adhesive layer and a transparent selective light absorbing layer containing a transparent material and a tetraazaphorpyrin compound, which is a selective light absorbing material, and fills the space in the metal pattern on the adhesive layer. The film will advantageously improve the color gamut and contrast of, for example, a PDP. Initially, an adhesive layer is formed on a transparent substrate. A meshed metal pattern is formed on the adhesive layer. Examples of the transparent substrate include polyethylene terephthalate (PET), Tri-acetyl-cellulose, (TAC), polyvinyl alcohol (PVA), polyethylene (PE), and the like. The transparent substrate may have a thickness of from about 10 to about 1000 μm, preferably, from about 50 to about 500 μm. The meshed metal pattern may be formed of, for example, Ag, Cu, Ni, Al, Au, Fe, Pt, or Cr. The adhesive layer is formed of an adhesive, and the like, for example, acrylic resin, polyester resin, epoxy resin, urethane resin, and the like. The adhesive layer may have a thickness of from about 1 to about 1000 μm, preferably, from about 10 to about 500 μm.

Methods of manufacturing a filter with a meshed metal pattern as described above are as follows. After a thin copper film is attached to a PET substrate using an adhesive, a mesh pattern having lattice type is formed in the thin copper film using etching. Alternatively, a plating method can be used after forming a pattern in a glass, a film, or a metal substrate. A method using a metallic fiber mesh, a printing method, and the like, can be used.

A mixture of a transparent material and a tetraazaphorpyrin compound, which is a selective light absorbing material, is applied to the space in the meshed metal pattern using screen printing, a table coater, a cap coater, a bar coater, a blade, and the like, dried and cured to obtain a transparent selective light absorbing layer.

In the curing process, UV curing, electron beam curing, or thermal curing can be used.

When the surface of the substrate coated with the mixture of the transparent material and the selective light absorbing material is irregular, the surface of the coated layer is processed to be even using a member with a smooth surface, for example, a glass substrate, and the like, and then the curing process is performed.

The transparent material may be a colorless and transparent material having a transmittance of about 90% or greater. Examples of such transparent materials include a UV hardener, an electron beam hardener, a thermal hardener, a binder, an adhesive, and the like. Examples of the UV hardener include unsaturated polyester resin, thiol-olefine resin, acrylic resins, epoxy resins, and the like. Examples of the electron beam hardener include a combination of a prepolymer and a multifunctional vinyl monomer, and the like. Examples of the thermal hardener include ureas, phenols, vinyl acetates, nitrile rubbers, acryls, neoprene rubbers, epoxy resins, polyurethanes, silicon rubbers, and the like. Examples of the adhesive and the binder include acrylic resins, and the like.

An example of the tetraazaphorpyrin compound may be a compound of formula (1) or (2) below.

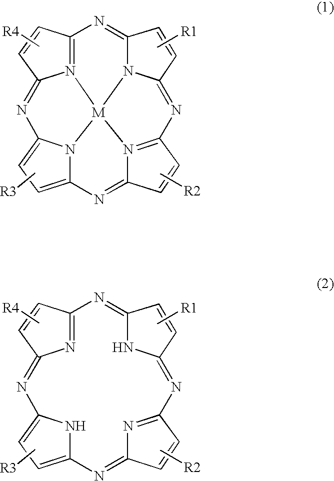

In formulae (1) and (2) above, each of R₁ through R₄ is independently selected from the group consisting of a substituted or unsubstituted C₁-C₂₀ alkyl group, a substituted or unsubstituted C₁-C₂₀ alkoxy group, a substituted or unsubstituted C₅-C₂₀ cycloalkyl group, a substituted or unsubstituted C₆-C₂₀ aryl group, a substituted or unsubstituted C₅-C₂₀ heteroaryl group with one or more fused or bonded rings and one or more heteroatoms selected from the group consisting of O, S, N and P, and a halogen atom; and M is selected from the group consisting of Ni, Mn, Mg, Co, and Cu. Suitable substituents include those selected from the group consisting of hydroxy, cyano, fluoro, chloro, bromo, iodo, amino, mono(C₁ to C₆ alkyl) substituted amino, di(C₁ to C₆ alkyl) substituted amino, C₁ to C₆ alkyl amino, C₁ to C₆ monosubstituted amino, C₁ to C₆ disubstituted amino, (wherein the amino substituents are independently C₁ to C₆ alkyl), as well as C₁ to C₆ carboxy ester, C₁ to C₆ aldehyde, C₁ to C₆ amide, and C₁ to C₆ acyl groups.

Specified examples of R₁ through R₄ include substitute groups, such as a propyl group, an isopropyl group, a butyl group, a tertiary butyl group, a cyclopentyl group, a cyclohexyl group, and the like.

The tetraazaphorpyrin compound of formula (1) or (2) may be a compound of formula (3), (4), or (5) below. 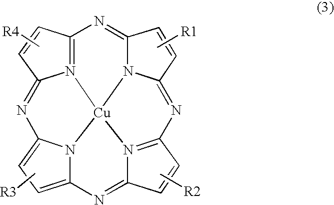
where each of R₁ through R₄ is independently a methyl group, a butyl group, or a phenyl group; 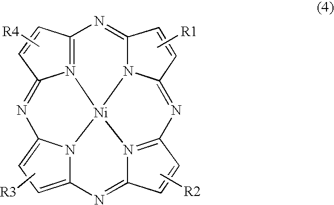
where each of R₁ through R₄ is independently a methyl group, a butyl group, or a phenyl group; 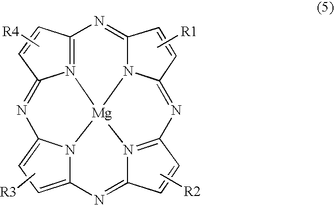
where each of R₁ through R₄ is independently a methyl group, a butyl group, or a phenyl group.

The amount of the tetraazaphorpyrin compound, which is a selective light absorbing material, may be in a range of from about 0.1 to about 20 parts by weight based on 100 parts by weight of the total transparent material and selective light absorbing material. If the amount of the selective light absorbing material is less than about 0.1 parts by weight, the absorbance is too low to provide an appropriate reproduction range of colors, and the transmittance of near infrared ray increases so that a malfunction is more likely to occur. If the amount of the selective light absorbing material exceeds about 20 parts by weight, undesirably the overall transmittance decreases.

The transparent selective light absorbing layer may have a thickness of from about 1 to about 1000 μm. If the thickness of the transparent selective light absorbing layer is smaller than about 1 μm, it is difficult to coat the transparent selective light absorbing layer to have a uniform thickness, the absorbance is too low to achieve an appropriate reproduction range of colors, and it is also difficult to sufficiently absorb near infrared rays. If the thickness of the transparent selective light absorbing layer is larger than about 1000 μm, bubbles are more likely to be generated during a subsequent process, and the coated layer cracks.

The EMI shielding film according to the present embodiments may have a transmittance of from about 30 to about 80%, a color temperature of from about 8000 to about 12000K, a conductivity of about 0.5 ohm/square or less, and a red chromaticity coordinate range of from about 0.58 to about 0.72 for x and from about 0.2 to about 0.4 for y. A preferred red chromaticity coordinate range may be from about 0.64 to about 0.70 for x and from about 0.24 to about 0.34 for y.

FIG. 3 shows the structure of an EMI shielding film 30 according to the present embodiments manufactured through the above-described processes. Referring to FIG. 3, an adhesive layer 32 is formed on a transparent substrate 31, and a metal pattern 33 is formed on the adhesive layer 32. The metal pattern 32 may have any shape without limitations. However, a meshed shape is preferred in consideration of the EMI shielding effect. A transparent selective light absorbing layer 34 containing a transparent material and a tetraazaphorpyrin compound, which is a selective light absorbing material, is formed in the space of the metal pattern 33.

Hereinafter, a plasma display pane including the above-described EMI shielding film will be described.

A plasma display panel according to the present embodiments includes a transparent front substrate, a rear substrate-arranged parallel to the front substrate, an EMI shielding film arranged a predetermined distance away from the front substrate, barrier ribs arranged between the front substrate and the rear substrate to define emission cells, address electrodes extending across a group of emission cells arranged in a direction and covered by a rear dielectric layer, a fluorescent layer formed on each of the emission cells, and sustain electrode pairs extending to intersect the address electrodes and covered by a front dielectric layer. The emission cells are filled with discharge gas.

The address electrodes are arranged between the rear substrate and the rear dielectric layer. The barrier ribs are formed on the rear dielectric layer. The sustain electrode pairs are arranged between the front substrate and the front dielectric layer. The front dielectric layer may be covered with a protective layer.

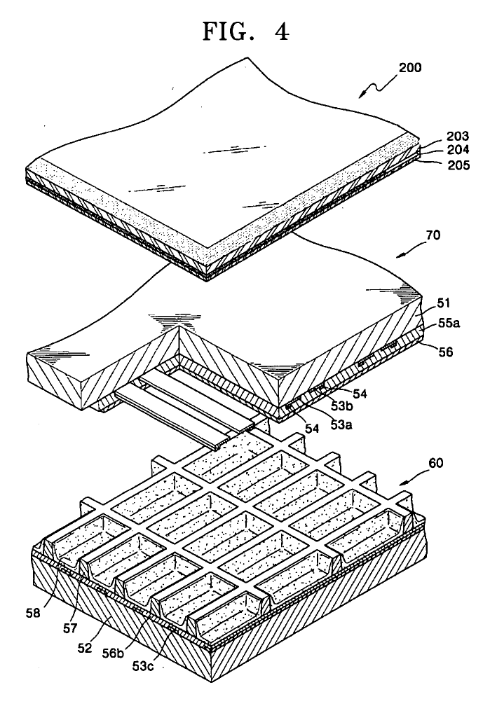

FIG. 4 is a partial perspective view illustrating a structure of a plasma display device including the EMI shielding film according to the present embodiments.

Referring to FIG. 4, the plasma display device includes a front panel 70 and a rear panel 60. An EMI shielding film 200 according to the present embodiments is arranged a predetermined distance in front of the front panel 70.

The EMI shielding film 200 has a structure in which a transparent substrate 203, an adhesive layer 204, and a meshed metal pattern 205, which faces the front panel 70, are sequentially stacked.

The front panel 70 includes a front substrate 51, sustain electrode pairs, each of which consists of Y and X electrodes, formed on a rear surface of the front substrate 51, a front dielectric layer 55a covering the sustain electrode pairs, and a protective layer 56 covering the front dielectric layer 55a. Each of the Y and X electrodes includes transparent electrodes 53a and 53b formed of a transparent material, such as ITO, and the like, and a bus electrode 54 formed of a highly conductive metal.

The rear panel 60 includes a rear substrate 52, address electrodes 53c formed on a front surface of the rear substrate 52 to intersect the sustain electrode pairs, a rear dielectric layer 56b covering the address electrodes 53c, barrier ribs 57 formed on the rear dielectric layer 56b to define emission cells, and a fluorescent layer 58 formed on each of the emission cells.

The present embodiments will be described in greater detail with reference to the following examples. The following examples are for illustrative purposes and are not intended to limit the scope of the embodiments.

### EXAMPLES

### Example 1

A thin Cu plate was attached to a surface of a polyethylene terephthalate (PET) substrate using a thermal hardener, which is a metal adhesive, and etched to obtain a meshed metal pattern.

99.5 parts by weight of a UV hardener (UV39003H-1, VFP Co. (Seoul, Republic of Korea)) as a transparent material and 0.5 parts by weight of the tetraazaphorpyrin compound of formula (3) where each of R₁ through R₄ is a butyl group were mixed to obtain a composition for forming a transparent selective light absorbing layer. The composition was coated to fill the space in the meshed metal pattern using screen printing and subjected to UV curing using a metal halide lamp to obtain the transparent selective light absorbing layer, thereby resulting in an EMI shielding film.

### Example 2

An EMI shielding film was manufactured in the same manner as in Example 1, except that the tetraazaphorpyrin compound of formula (4) where each of R₁ through R₄ is a butyl group was used instead of the tetraazaphorpyrin compound of formula (3) to form the transparent selective light absorbing layer.

### Example 3

An EMI shielding film was manufactured in the same manner as in Example 1, except that the tetraazaphorpyrin compound of formula (5) where each of R₁ through R₄ is a butyl group was used instead of the tetraazaphorpyrin compound of formula (3) to form the transparent selective light absorbing layer.

### Example 4

An EMI shielding film was manufactured in the same manner as in Example 1, except that the amount of the tetraazaphorpyrin compound of formula (3) was changed from 0.5 parts by weight to 0.36 parts by weight to form the transparent selective light absorbing layer.

### Example 5

An EMI shielding film was manufactured in the same manner as in Example 2, except that the amount of the tetraazaphorpyrin compound of formula (4) was changed from 0.5 parts by weight to 0.36 parts by weight to form the transparent selective light absorbing layer.

### Example 6

An EMI shielding film was manufactured in the same manner as in Example 3, except that the amount of the tetraazaphorpyrin compound of formula (5) was changed from 0.5 parts by weight to 0.36 parts by weight to form the transparent selective light absorbing layer.

### Comparative Example 1

A thin Cu plate was attached to a surface of a PET substrate using a thermal hardener, which is a metal adhesive, and etched to obtain a meshed metal pattern.

100 g of a UV hardener, which is a transparent material that includes a polyurethane oligomer, methacrylate and a photoinitiator, was coated to fill the space in the meshed metal pattern using screen printing and irradiated with light having a wavelength of 240-450 nm to obtain a transparent coated layer, thereby resulting in an EMI shielding film.

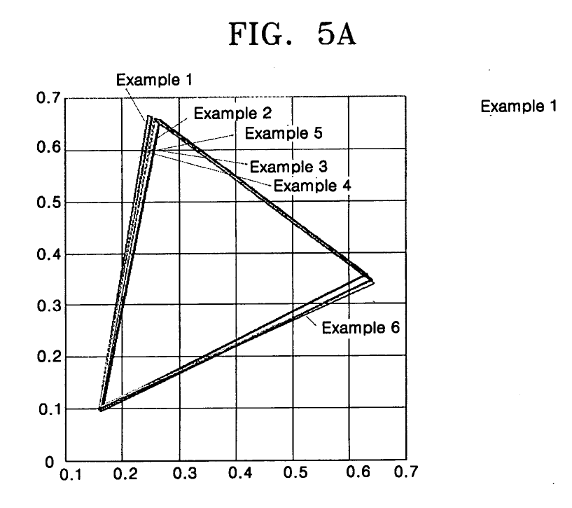

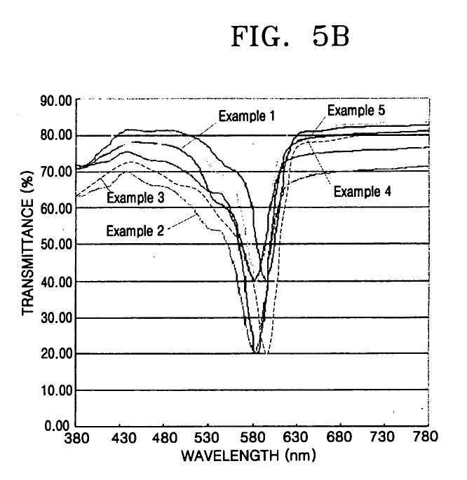

The optical spectrum of each of the EMI shielding films manufactured in Examples 1 through 6 was measured. The results are shown in FIG. 5B.

Referring to FIG. 5B, an absorption peak appeared near 584 nm when the tetraazaphorpyrin compound of formula (3) was used, an absorption peak appeared near 582 nm when the tetraazaphorpyrin compound of formula (4) was used, and an absorption peak appeared near 596 nm when the tetraazaphorpyrin compound of formula (5) was used.

The color temperature, reproduction range of colors, and chromaticity coordinate of each of the EMI shielding films manufactured in Example 1 through 6 and Comparative Example 1 were measured. The results are shown in FIG. 5A and Table 1 below.

TABLE 1

| | Color | Color | | | | | | |
|---|---|---|---|---|---|---|---|---|
| | temperature | reproduction | Red (R) | | Green (G) | | Blue (B) | |
| Example | (K) | range (%) | x | y | x | y | x | y |
| Example1 | 9346 | 9.34 | 0.645 | 0.340 | 0.246 | 0.668 | 0.159 | 0.102 |
| Example 2 | 8591 | 5.37 | 0.642 | 0.346 | 0.255 | 0.663 | 0.162 | 0.105 |
| Example 3 | 10733 | 6.28 | 0.642 | 0.345 | 0.251 | 0.663 | 0.160 | 0.104 |
| Example 4 | 8924 | 7.77 | 0.642 | 0.344 | 0.251 | 0.662 | 0.160 | 0.095 |
| Example 5 | 8530 | 6.41 | 0.640 | 0.347 | 0.254 | 0.660 | 0.161 | 0.094 |
| Example 6 | 9691 | 8.16 | 0.642 | 0.343 | 0.250 | 0.665 | 0.160 | 0.097 |
| Comparative | 6924 | 0.00 | 0.632 | 0.357 | 0.266 | 0.658 | 0.166 | 0.104 |
| Example 1 | | | | | | | | |

Referring to Table 1 above, the EMI shielding films according to Examples 1 through 6 are improved in color temperature, reproduction range of colors, and chromaticity coordinate characteristic compared with the EMI shielding film according to Comparative Example 1, thus providing an improved color gamut.

As described above, an EMI shielding film according to the present embodiments is improved in color gamut, contrast, and thermal stability compared with conventional meshed films. Since the EMI shielding film can shield EMI and improve the color gamut, the number of binding processes and other additional processes in the manufacturing of filters are reduced compared with conventional methods. In addition, the EMI shielding film can be directly and easily attached to a panel of a plasma display device.

While the present embodiments have been particularly shown and described with reference to exemplary embodiments thereof, it will be understood by those of ordinary skill in the art that various changes in form and details may be made therein without departing from the spirit and scope of the present embodiments as defined by the following claims.

What is claimed is:

1. An electromagnetic interference shielding film comprising:
an adhesive layer formed on a transparent substrate;
a metal pattern formed on the adhesive layer; and
a transparent selective light absorbing layer containing a transparent material and a tetraazaphorpyrin compound, which is a selective light absorbing material, and fills the space in the metal pattern on the adhesive layer.

2. The electromagnetic interference shielding film of claim 1, wherein the tetraazaphorpyrin compound is a compound of formula (1): 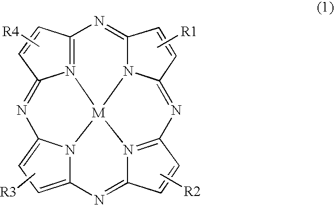
wherein each of R₁ through R₄ is independently selected from the group consisting of a substituted or unsubstituted C₁-C₂₀ alkyl group, a substituted or unsubstituted C₁-C₂₀ alkoxy group, a substituted or unsubstituted C₅-C₂₀ cycloalkyl group, a substituted or unsubstituted C₆-C₂₀ aryl group, a substituted or unsubstituted C₅-C₂₀ heteroaryl group, and a halogen atom; and M is selected from the group consisting of Ni, Mn, Mg, Co, and Cu.

3. The electromagnetic interference shielding film of claim 1, wherein the tetraazaphorpyrin compound is a compound of formula (2): 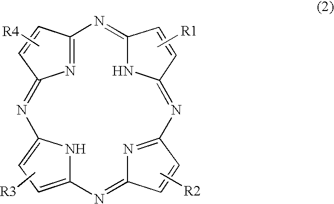
wherein each of R₁ through R₄ is independently selected from the group consisting of a substituted or unsubstituted C₁-C₂₀ alkyl group, a substituted or unsubstituted C₁-C₂₀ alkoxy group, a substituted or unsubstituted C₅-C₂₀ cycloalkyl group, a substituted or unsubstituted C₆-C₂₀ aryl group, a substituted or unsubstituted C₅-C₂₀ heteroaryl group, and a halogen atom.

4. The electromagnetic interference shielding film of claim 2, wherein the compound is a compound of formula (3) below: 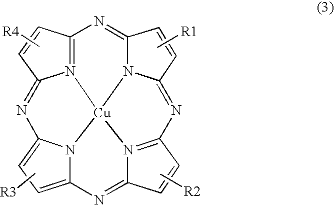
wherein each of R₁ through R₄ is independently a methyl group, a butyl group, or a phenyl group.

5. The electromagnetic interference shielding film of claim 2, wherein the compound is a compound of formula (4) below: 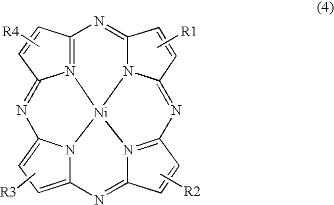
wherein each of R₁ through R₄ is independently a methyl group, a butyl group, or a phenyl group.

6. The electromagnetic interference shielding film of claim 2, wherein the compound is a compound of formula (5) below: 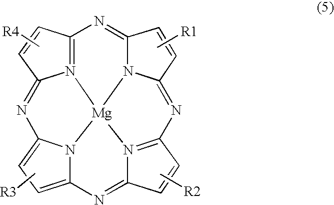
wherein each of R₁ through R₄ is independently a methyl group, a butyl group, or a phenyl group.

7. The electromagnetic interference shielding film of claim 1, wherein the metal pattern has a mesh shape.

8. The electromagnetic interference shielding film of claim 1, wherein the selective light absorbing material is a material selectively absorbing light having a wavelength of from about 550 to about 610 nm.

9. The electromagnetic interference shielding film of claim 1, wherein the transparent material is at least one selected from the group consisting of polyester resin, thiol-olefin resin, acrylic resins, epoxy resins, a combination of a prepolymer and a multifunctional vinyl monomer, ureas, phenols, vinyl acetates, nitrile rubbers, acryls, neoprene rubbers, epoxy resins, polyurethanes, and silicon rubbers.

10. The electromagnetic interference shielding film of claim 1, wherein the amount of the selective light absorbing material in the transparent selective absorbing layer is in a range of from about 0.1 to about 20 parts by weight based on 100 parts by weight of the total transparent material and selective light absorbing material.

11. The electromagnetic interference shielding film of claim 1, wherein the transparent selective light absorbing layer has a thickness of from about 1 to about 200 μm.

12. The electromagnetic interference shielding film of claim 1, having a transmittance of from about 30% to about 80%.

13. The electromagnetic interference shielding film of claim 1, having a color temperature of from about 8000K to about 12000K.

14. The electromagnetic interference shielding film of claim 1, having a conductivity of about 0.5 ohm/square or less.

15. The electromagnetic interference shielding film of claim 1, having a red chromaticity coordinate range of from about 0.64 to about 0.70 for x and from about 0.24 to about 0.34 for y.

16. A plasma display device using the electromagnetic interference shielding film according to claim 1.

17. A plasma display device using the electromagnetic interference shielding film according to claim 2.

18. A plasma display device using the electromagnetic interference shielding film according to claim 3.

19. A plasma display device comprising the electromagnetic interference shielding film of claim 2, wherein the compound is selected from a compound of formula (3) below: 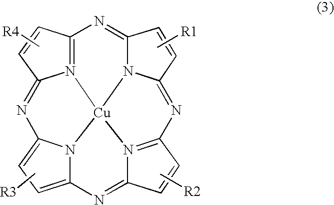
wherein each of R₁ through R₄ is independently a methyl group, a butyl group, or a phenyl group; a compound of formula (4) below: 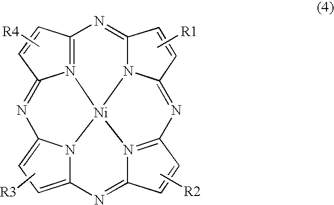
wherein each of R₁ through R₄ is independently a methyl group, a butyl group, or a phenyl group; or a compound of formula (5) below: 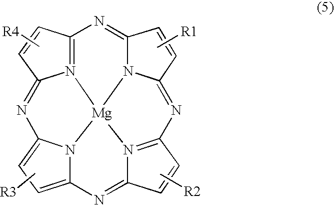
wherein each of R₁ through R₄ is independently a methyl group, a butyl group, or a phenyl group.

20. A plasma display panel comprising:
a transparent front substrate;
a rear substrate arranged parallel to the front substrate;
the electromagnetic interference shielding film of claim 1 arranged a predetermined distance away from the front substrate;
barrier ribs arranged between the front substrate and the rear substrate;
address electrodes extending across a group of emission cells covered by a rear dielectric layer;
a fluorescent layer formed on each of the emission cells;
and sustain electrode pairs extending to intersect the address electrodes and covered by a front dielectric layer.
